(19) United States
(12) Patent Application Publication
(10) Pub. No.: US 2008/0205338 A1
(43) Pub. Date: Aug. 28, 2008

(54) METHOD AND APPARATUS FOR ALLOCATING RESOURCES IN COMMUNICATION SYSTEMS

(75) Inventors: Jae-Woo SO, Bucheon-si (KR); June MOON, Seoul (KR); Yong-Seok KIM, Suwon-si (KR); Soon-Young YOON, Seoul (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/037,350

(22) Filed: Feb. 26, 2008

(30) Foreign Application Priority Data
Feb. 26, 2007 (KR) 2007-0019138

(51) Int. Cl. H04Q 7/00

(52) U.S. Cl. 370/329

(57) ABSTRACT

A resource allocation method and apparatus in a communication system having backward compatibility are provided. In a transmission apparatus, a determiner determines a first frequency band for transmitting wireless resource allocation information to a terminal from among the frequency bands supporting the communication system, a MAP generator determines at least one second frequency band over which the terminal desires to receive a service and allocates wireless resources to the second frequency band, and a transmission unit transmits the wireless resource allocation information to the terminal over the first frequency band. In a reception apparatus, a reception unit receives wireless resource allocation information over a first frequency band determined by a base station and a MAP information decrypter determines at least one service frequency band included in the wireless resource allocation information. Accordingly, the method and apparatus dynamically allocate wireless resources to a terminal when multiple systems having backward compatibility coexist.

### PRIORITY

This application claims the benefit under 35 U.S.C. §119(a) of a Korean Patent Application filed in the Korean Intellectual Property Office on Feb. 26, 2007 and assigned Serial No. 2007-19138, the entire disclosure of which is hereby incorporated by reference.

### BACKGROUND OF THE INVENTION

1. Field of the Invention

The present invention relates to a method and apparatus for providing wireless resources in communication systems.

2. Description of the Related Art

As a result of continuing research and development in communication system design, mobile communication systems are evolving. Specifically, standards of the existing systems are being modified to provide higher-speed data services and implementation issues are being solved. For example, the Code Division Multiplex Access (CDMA) system has evolved from CDMA 1x into Evolution Data Only (EV-DO). When evolution between systems is made in this way, various systems having different service levels may coexist such that backward compatibility is necessary with the existing systems. Therefore, a situation may occur in which it is necessary to support both the communication system that was in place before the evolution as well as the communication system that is in place after the evolution.

As part of the evolution of communication systems, it is also desirable to maximize the capacity of the system. To achieve the capacity maximization while making the evolution, it is necessary not only to modify the system standards but also to use additional frequency bands.

FIG. 1 illustrates a distribution of frequency bands of a CDMA 1X system and an EV-DO system in a communication system according to the conventional art.

Referring to FIG. 1, the communication system includes a CDMA 1X system and an EV-DO system, both of which use different resources. That is, the CDMA 1X system and the EV-DO system use different frequency bands 100 and 102 independently. The communication system further includes a CDMA 1X system-only terminal 104, which supports only a band-1 100 that is an operation frequency band (or service frequency band) of the CDMA 1X system, an EV-DO system-only terminal 108, which supports only a band-2 102 that is an operation frequency band of the EV-DO system, and a switching terminal 106, which supports both the CDMA 1X system and the EV-DO system.

The phrase ‘switching terminal 106, which supports both the CDMA 1X system and the EV-DO system’ means that the switching terminal 106 can switch to either of the CDMA 1x system or the EV-DO system rather than simultaneously accessing the two systems to receive service therefrom.

Similar to the CDMA system described above, it is expected that the IEEE 802.16e system will also experience evolution over time. After such an evolution, the predecessor IEEE 802.16e system may be hereinafter referred to as a ‘legacy system’ and the evolved system can be classified as a system having Backward Compatibility (BC) with the legacy system, which may hereinafter be referred to as a ‘BC system’.

One service provider, while providing the IEEE 802.16e service using an arbitrary frequency band, can upgrade a legacy system to a BC system for the purpose of performance improvement and to meet the need for capacity increase, and can also build another BC system in another arbitrary frequency band, as shown in FIGS. 2 and 3.

FIG. 2 illustrates a distribution of frequency bands when a legacy system and a system having backward compatibility coexist according to the conventional art.

Referring to FIG. 2, a band-1 200 is a service frequency band (or operation frequency band) of a legacy system, and a band-2 202 is a service frequency band of a BC system. In this case, a legacy terminal 204 can perform communication only over band-1 200, and a BC terminal 206 can perform communication over both band-1 200 and band-2 202.

FIG. 3 illustrates a distribution of frequency bands when multiple systems having backward compatibility coexist according to the conventional art.

Referring to FIG. 3, a band-1 300 is a service frequency band of a BC1 system and a band-2 302 is a service frequency band of a BC2 system. While a legacy terminal 304 can perform communication only over band-1 300, a BC terminal 306 can perform communication over both band-1 300 and band-2 302.

FIG. 4 illustrates a resource allocation method in multiple communication systems according to the conventional art. The multiple communication systems are assumed herein to be IEEE 802.16e systems, by way of example.

Referring to FIG. 4, the conventional IEEE 802.16e system allocates Downlink (DL) resources and Uplink (UL) resources by transmitting MAP Information Element (MAP_IE) information in a DL frame. That is, in a channel using band-1 400, the IEEE 802.16e system allocates resources of only band-1 400 using MAP information 410. Similarly, in a channel using band-2 405, the IEEE 802.16e system allocates resources of only band-2 405 using MAP information 415.

A terminal using a particular frequency band is allocated resources only in that particular frequency band. That is, in FIG. 1, the CDMA 1X system-only terminal 104 is allocated resources over band-1 100. The switching terminal 106, when it receives service in band-i 100, is allocated resources in band-1 100, and the switching terminal 106, when it receives service in band-2 102, is allocated resources in band-2 102. The EV-DO system-only terminal 108 receives service in band-2 102.

In FIG. 2, the legacy terminal 204 is allocated resources in band-1 200. The BC terminal 206, when it receives service in band-1 200, is allocated resources in band-1 200, and the BC terminal 206, when it receives service in band-2 202, is allocated resources in band-2 202.

In FIG. 3, the legacy terminal 304 is allocated resources in band-1 300. The BC terminal 306, when it receives service over band-1 300, is allocated resources over band-1 300, and the BC terminal 306, when it receives service over band-2 302, is allocated resources over band-2 302.

As described above, in the conventional IEEE 802.16e system, the base station allocates resources only in the frequency band in which the corresponding terminal is receiving service. Therefore, in the case where the base station can broadcast resource allocation information in another arbitrary frequency band but cannot broadcast resource allocation information in the corresponding frequency band, the base station cannot allocate resources in the corresponding frequency band, making it impossible to provide a particular service to the terminal in the corresponding frequency band.

### SUMMARY OF THE INVENTION

An aspect of the present invention is to address at least the above-mentioned problems and/or disadvantages and to provide at least the advantages described below. Accordingly, an aspect of the present invention is to provide a method and apparatus for dynamically allocating wireless resources to a terminal when multiple systems having backward compatibility coexist.

Another aspect of the present invention is to provide a method and apparatus in which, when multiple systems having backward compatibility coexist, a base station dynamically provides wireless resource allocation information using an arbitrary frequency band independent of the frequency band being used by the terminal, thereby improving utilization efficiency of resources.

According to one aspect of the present invention, a method for allocating resources in a communication system is provided. The method includes determining a first frequency band for transmitting wireless resource allocation information to a terminal from among frequency bands supporting the communication system, determining at least one second frequency band over which the terminal desires to receive a service, generating wireless resources allocation information for allocation of to the second frequency band and transmitting the wireless resource allocation information to the terminal over the first frequency band.

According to another aspect of the present invention, a method for receiving wireless resources in a communication system having backward compatibility is provided. The method includes receiving wireless resource allocation information over a first frequency band determined by a base station, determining at least one service frequency band included in the wireless resource allocation information and receiving data over the checked service frequency band.

According to still another aspect of the present invention, an apparatus for allocating resources in a communication system is provided. The apparatus includes a determiner for determining a first frequency band for transmitting wireless resource allocation information to a terminal from among frequency bands supporting the communication system, a MAP generator for determining at least one second frequency band over which the terminal desires to receive a service and for allocating wireless resources to the second frequency band and a transmission unit for transmitting the wireless resource allocation information to the terminal over the first frequency band.

According to yet another aspect of the present invention, an apparatus for receiving wireless resources in a communication system having backward compatibility is provided. The apparatus includes a reception unit for receiving wireless resource allocation information over a first frequency band determined by a base station and a MAP information decrypter for determining at least one service frequency band included in the wireless resource allocation information.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will become more apparent from the following detailed description taken in conjunction with the accompanying drawings in which:

FIG. 1 illustrates distribution of frequency bands of a CDMA 1X system and an EV-DO system in a communication system according to the conventional art;

FIG. 2 illustrates exemplary distribution of frequency bands when multiple systems having backward compatibility coexist according to the conventional art;

FIG. 3 illustrates another exemplary distribution of frequency bands when multiple systems having backward compatibility coexist according to the conventional art;

FIG. 4 illustrates a resource allocation method in multiple communication systems according to the conventional art;

FIG. 5 illustrates a resource allocation method according to an exemplary embodiment of the present invention;

FIG. 6 illustrates an operation of a base station according to an exemplary embodiment of the present invention;

FIG. 7 illustrates an operation of a terminal according to an exemplary embodiment of the present invention;

FIG. 8 illustrates a structure of a base station according to an exemplary embodiment of the present invention; and

FIG. 9 illustrates a structure of a terminal according to an exemplary embodiment of the present invention.

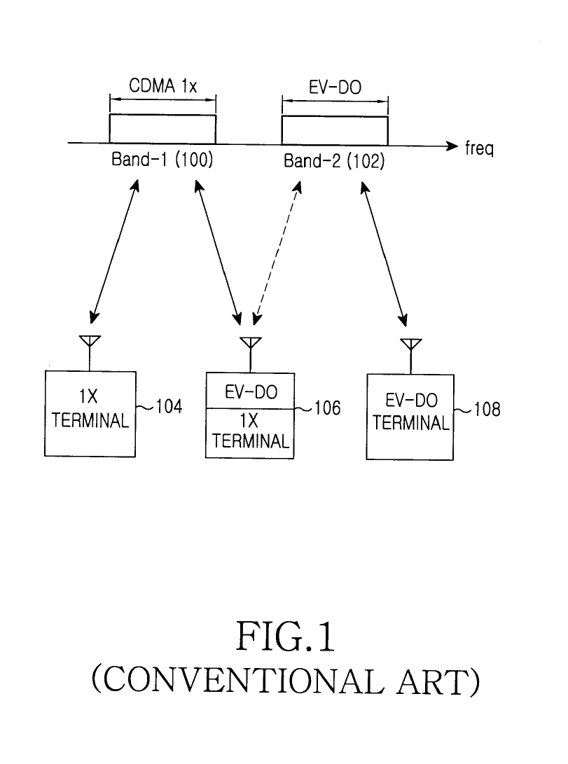

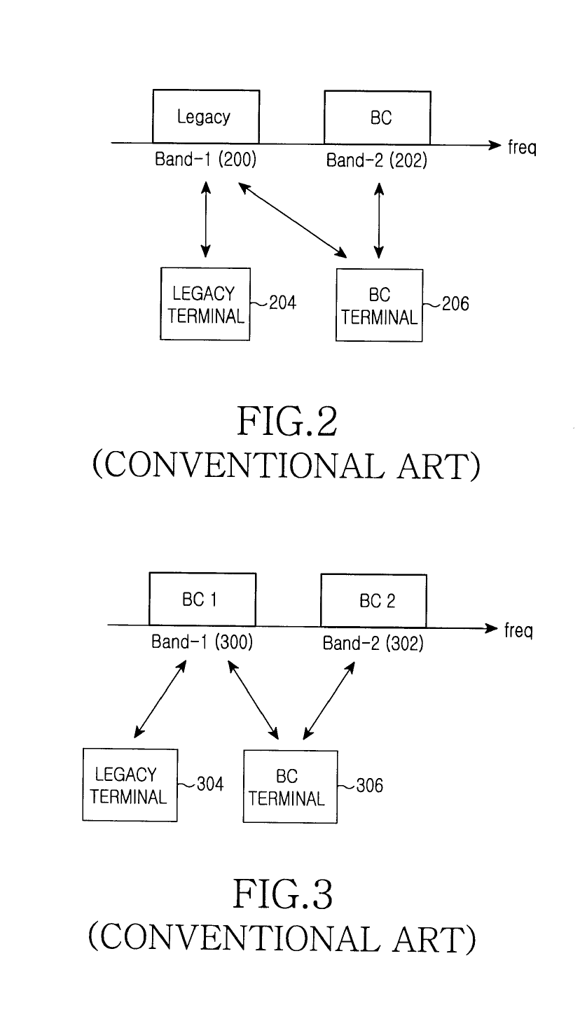

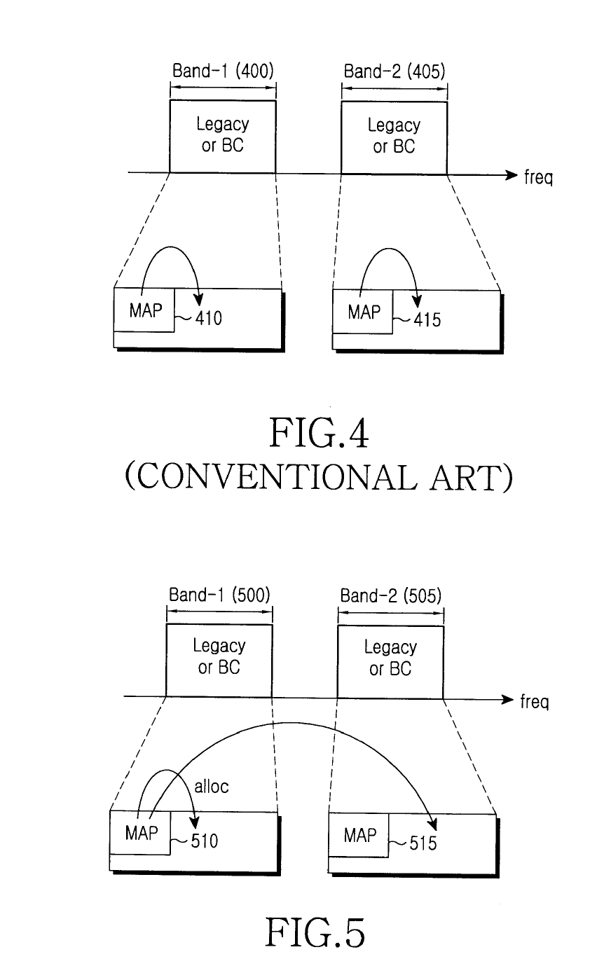

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and configurations are omitted for clarity and conciseness.

Exemplary embodiments of the present invention provide a method and apparatus for dynamically allocating wireless resources to a terminal when multiple communication systems having backward compatibility coexist. Although an exemplary description of the present invention will be directed herein with reference to the IEEE 802.16e communication system, this is merely by way of example and the present invention can be applied to other communication systems. A configuration of the IEEE 802.16e communication system includes a base station(s) and a terminal(s). In this configuration, a transmission side can be a base station or a terminal and a reception side can be a terminal or a base station. Although the description will be directed to the case where the base station serves as a transmission side and the terminal serves as a reception side, this is merely by way of example and the same teachings can be applied even to the case where the terminal serves as a transmission side and the base station serves as a reception side.

Specifically, exemplary embodiments of the present invention provide a method and apparatus in which, when multiple communication systems having backward compatibility coexist, a base station dynamically provides wireless resource allocation information using an arbitrary frequency band independent of the frequency band being used by the terminal, thereby improving utilization efficiency of resources.

FIG. 5 illustrates a resource allocation method according to an exemplary embodiment of the present invention.

Referring to FIG. 5, in the illustrated example a base station has, as its operation frequency bands, a band-1 500 and a band-2 505 each supportable by a legacy system or a BC system. In this case, the base station can allocate DL and UL resources of the band-1 500 or the band-2 505, or can allocate DL and UL resources of both the band-1 500 and the band-2 505 using MAP_IE information 510 broadcast in the band-1 500 regardless of the frequency band being used by the terminal.

Although not shown, the base station can also allocate DL and UL resources of the band-1 500 or the band-2 505, or can allocate DL and UL resources of both the band-1 500 and the band-2 505 using MAP_IE information 515 broadcast in the band-2 505.

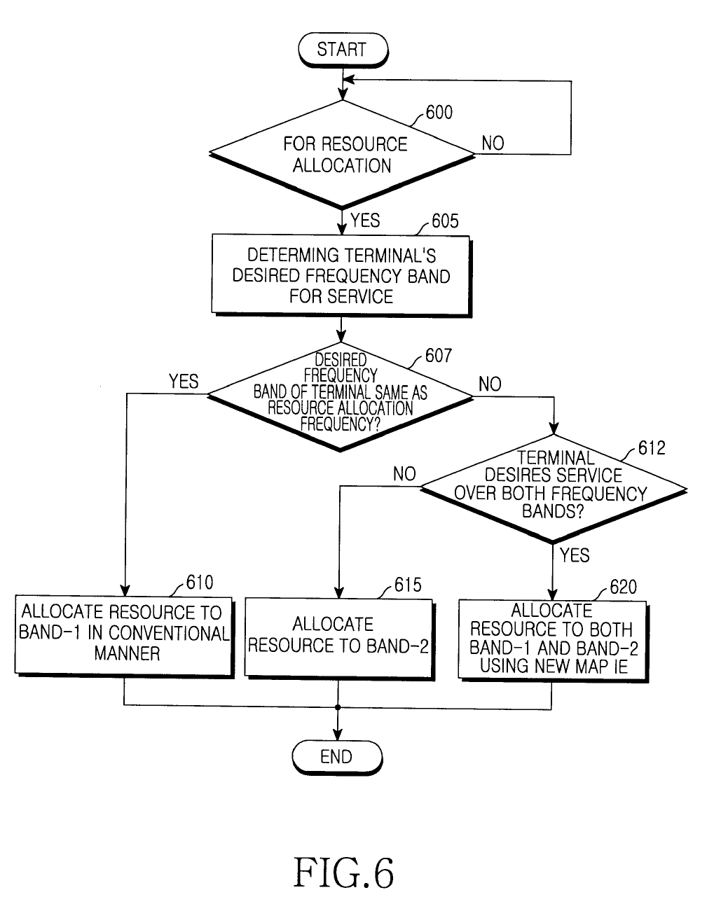

FIG. 6 illustrates an operation of a base station according to an exemplary embodiment of the present invention. In the illustrated example, the base station uses a band-1 and a band-2 as its service frequency bands.

Referring to FIG. 6, in step 600, the base station determines a frequency band where it will allocate resources to provide a corresponding service to a terminal. Here, the frequency band where the base station will allocate resources is determined according to the resource condition of the band-1 and the band-2, independent of the frequency band where the terminal desires to receive a service. For sake of example only, it will be assumed herein that the base station has determined to allocate resources to the terminal over the band-1. Of course, it must be understood that this is merely an example and that the base station may allocate resources on either of band-1 or band-2 or any number of other bands within the control of the base station.

In step 605, the base station determines a frequency band in which the terminal desires to receive service. In step 607, it is determined if the terminal desires to receive service over the same band as the base station has determined for allocation of resources, in this example band-1. If the terminal desires to receive service over the same band as determined by the base station for resource allocation, the base station allocates in step 610 resources to the band-1 using the same MAP_IE( ) of the band-1 as in the conventional art. If it is determined that the terminal does not desire to receive service on the same band as the resource allocation band of the base station in step 607, it is determined in step 612 if the terminal desires to receive service over both the band-1 and the band-2. If it is determined that the terminal desires to receive a service over the band-2 only, that is, the terminal does not desire to receive service over both the band-1 and the band-2, the base station allocates, in the band-1, resources to the band-2 using a new MAP_IE( ) in step 615. A standard of the new MAP_IE( ) transmitted from the band-1 depends on the standard of the band-2. If it is determined in step 612 that the terminal does desire to receive a service over both the band-1 and the band-2, the base station allocates, in the band-1, resources to both the band-1 and the band-2 using the new MAP_IE( ) in step 620. Similarly, a standard of the new MAP_IE( ) transmitted from the band-1 depends on the standard of the band-2.

Table 1 and Table 2 show formats of DL_MAP_IE( ) and UL_MAP_IE( ) defined to allocate resources to different frequency bands when multiple systems having backward compatibility coexist according to an exemplary embodiment of the present invention, respectively.

TABLE 1

| New_DL_MAP_IE | Bits | Notes |
|---|---|---|
| Extended-2 DIUC | 4 | |
| Length | 8 | Length in bytes |
| Frequency Band Index | 4 | Index of the band where it is intended |
| | | to provide a service |
| DL_MAP_IE( ) | Variable | DL_MAP_IE( ) standard in the band |
| | | where it is intended to provide |
| | | a service |

Referring to Table 1, a Frequency Band Index field and a DL_MAP_IE( ) field are newly added to the conventional DL_MAP_IE. The Frequency Band Index indicates with 4 bits an index of the band where a DL MAP of the band-1 intends to provide a service. The Frequency Band Index can indicate either one or both of the band-1 and the band-2. The DL-MAP_IE( ) field indicates a DL_MAP_IE( ) standard of the band where it is intended to provide a service.

TABLE 2

| New_UL_MAP_IE | bits | Notes |
|---|---|---|
| Extended-2 DIUC | 4 | |
| Length | 8 | Length in bytes |
| Frequency Band Index | 4 | Index of the band where it is intended |
| | | to provide a service |
| UL_MAP_IE( ) | variable | UL_MAP_IE( ) standard in the band |
| | | where it is intended to provide |
| | | a service |

Referring to Table 2, a Frequency Band Index field and a UL_MAP_IE( ) field are newly added to the conventional UL_MAP_IE. The Frequency Band Index indicates with 4 bits an index of the band where a UL MAP of the band-1 intends to provide a service. The Frequency Band Index can indicate either one or both of the band-1 and the band-2. The UL_MAP_IE( ) field indicates a UL_MAP_IE( ) standard of the band where it is intended to provide a service.

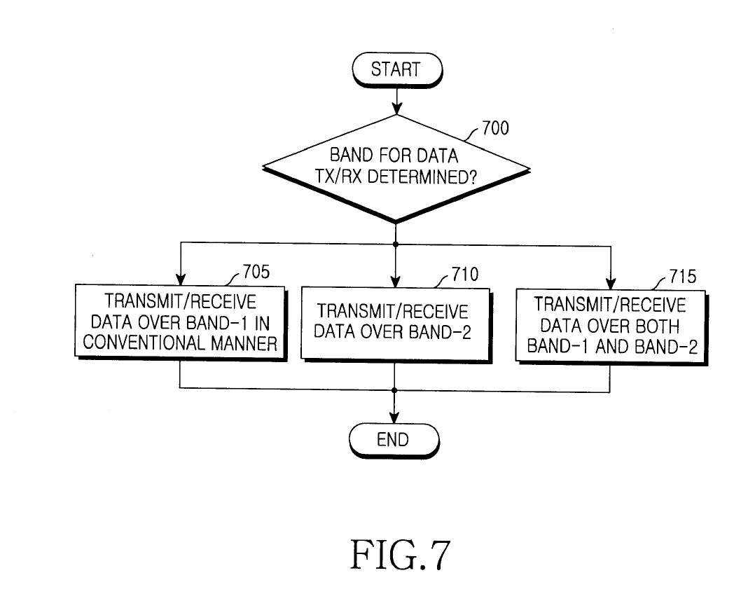

FIG. 7 illustrates an operation of a terminal according to an exemplary embodiment of the present invention.

Referring to FIG. 7, in step 700, the terminal decrypts a MAP received from the base station to determine the band over which the base station will transmit/receive data. That is, the terminal determines the corresponding band by evaluating the Frequency Band Index field of the MAP formats shown in Table 1 and Table 2.

If it is determined the Frequency Band Index indicates band-1, the terminal transmits/receives, in step 705, data of the service provided by band-1 using the same MAP_IE( ) as the conventional one, which is received in band-1. However, if it is determined that the Frequency Band Index indicates band-2, the terminal transmits/receives, in step 710, data of the service provided by the band-2 using the new MAP_IE( ) defined in Table 1 or Table 2, which is received in band-1. However, if it is determined that the Frequency Band Index indicates both band-1 and band-2, the terminal transmits/receives, in step 715, data of the service provided by both the band-1 and the band-2 using the new MAP_IE( ) defined in Table 1 or Table 2, which is received in band-1.

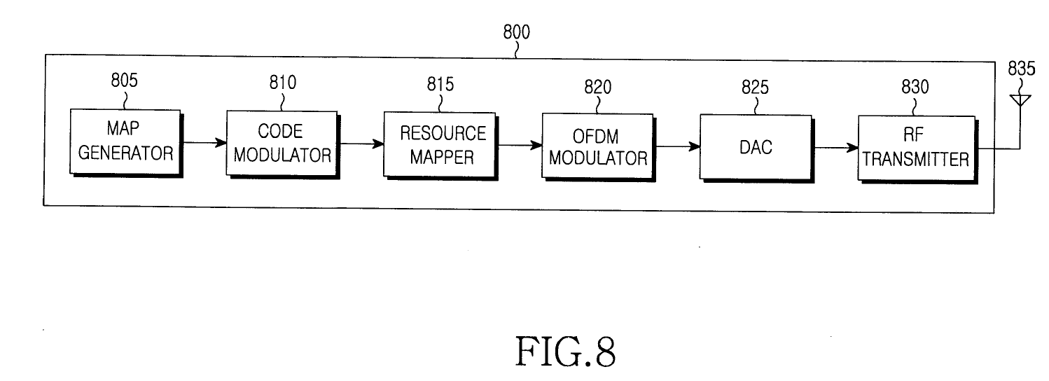

FIG. 8 illustrates a structure of a base station according to an exemplary embodiment of the present invention. Although a base station 800 is assumed herein to use a band-1 and a band-2 as its service frequency bands, the present invention can be applied to other communication systems where three or more bands are used.

Referring to FIG. 8, the base station 800 includes a MAP generator 805, a code modulator 810, a resource mapper 815, an Orthogonal Frequency Division Multiplexing (OFDM) modulator 820, a Digital-to-Analog Converter (DAC) 825, a Radio Frequency (RF) transmitter 830 associated with each band and a transmit antenna 835.

When the base station 800 has data to transmit to the terminal, the MAP generator 805 determines the resource condition of band-1 and band-2 to determine the band where it will allocate resources to the terminal. In an exemplary implementation, the MAP generator 805 determines that band-1 is the frequency band where it will allocate resources to the terminal.

Thereafter, if the band over which the terminal desires to receive a service is inconsistent with the determined resource allocation band, the MAP generator 805 generates a MAP_IE( ) including a corresponding standard of the band over which the terminal desires to receive service and an indicator indicating the same, and delivers the generated MAP_IE( ) to the code modulator 810. The MAP generator 805 modulates a DL MAP with the MAP_IE( ) by means of the code modulator 810 and then transfers the modulated DL MAP to the resource mapper 815.

Operations of the OFDM modulator 820, the DAC 825, the RF transmitter 830 and the transmit antenna 835, after allocating the DL MAP for transmission data, are substantially the same as conventional operations, so a detailed description thereof will be omitted herein for simplicity.

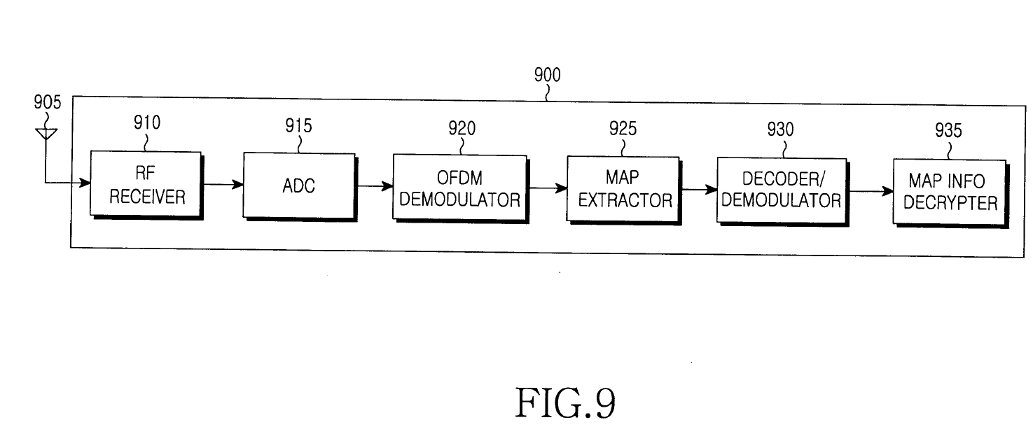

FIG. 9 illustrates a structure of a terminal according to an exemplary embodiment of the present invention. Herein, the terminal 900 can transmit/receive data over a band-1 and a band-2.

Referring to FIG. 9, the terminal 900 includes a receive antenna 905, an RF receiver 910, a Analog-to-Digital Converter (ADC) 915, an OFDM demodulator 920, a MAP extractor 925, a decoder/demodulator 930 and a MAP information decrypter 935.

The RF receiver 910 receives data from the transmission side via the receive antenna 905, digitally-converts the received data by means of the ADC 915, and then transfers the digitally-converted data to the MAP extractor 925 by way of the OFDM demodulator 920.

The MAP extractor 925 extracts the band where the terminal 900 is allocated resources and the band where it desires to receive a service, from the MAP allocated to the corresponding band over which the RF receiver 910 has received a packet, and then delivers the extracted band information to the MAP information decrypter 935 by way of the decoder/demodulator 930.

The MAP information decrypter 935 decrypts the extracted band information to determine whether the resource allocation band is consistent with the band where the terminal 900 desires to receive a service, evaluates a Frequency Band Index field of the MAP and, based on the evaluation, receives corresponding data over the band where the terminal desires to receive a service. The resource allocation band is assumed herein to be band-1. In this case, if the frequency band over which the terminal desires to receive a service is band-1, the terminal receives data in the conventional method. If the frequency band over which the terminal desires to receive a service is band-2, the terminal receives data over band-2. If the frequency band over which the terminal desires to receive a service is both band-1 and band-2, the terminal receives data over both band- 1 and band-2.

As is apparent from the foregoing description, according to an exemplary embodiment of the present invention, when multiple communication systems having backward compatibility coexist, the base station dynamically provides wireless resource allocation information using an arbitrary frequency band regardless of the frequency band providing service to the terminal, thereby contributing to an improvement of resource efficiency.

While the invention has been shown and described with reference to a certain exemplary embodiment thereof, it will be understood by those skilled in the art that various changes in form and details may be made therein without departing from the spirit and scope of the invention as defined by the appended claims and their equivalents.

What is claimed is:

1. A method for allocating resources in a communication system, the method comprising:
determining a first frequency band for transmitting wireless resource allocation information to a terminal from among frequency bands supported by the communication system;
determining at least one second frequency band over which the terminal desires to receive a service;
generating wireless resource allocation information for allocation of the second frequency band; and
transmitting the wireless resource allocation information to the terminal over the first frequency band.

2. The method of claim 1, wherein the generating of the wireless resource allocation information comprises generating wireless resource allocation information comprising an identifier of the second frequency band and a message format compliant with a standard of the second frequency band when the standard of second frequency band is different from that of the first frequency band.

3. The method of claim 2, wherein the message format compliant with the standard of the second frequency band comprises a DL_MAP_IE including a Frequency Band Index field and a DL_MAP_IE( ) field.

4. The method of claim 1, wherein the generating of the wireless resource allocation information comprises, when the second frequency band includes at least two different frequency bands and one of them is the first frequency band, generating wireless resource allocation information including identifiers and messages format compliant with standards of the at least two frequency bands.

5. A method for receiving wireless resources in a communication system having backward compatibility, the method comprising:
receiving wireless resource allocation information over a first frequency band determined by a base station;
checking at least one service frequency band included in the wireless resource allocation information; and
receiving data over the checked service frequency band.

6. The method of claim 5, wherein, when the service frequency band comprises a frequency band different from the first frequency band, the wireless resource allocation information comprises an identifier of the service frequency band and message format compliant with a standard of the service frequency band.

7. The method of claim 6, wherein the message format compliant with the standard of the second frequency band comprises a DL_MAP_IE including a Frequency Band Index field and a DL_MAP_IE( ) field.

8. The method of claim 5, wherein, when the service frequency band comprises at least two different frequency bands and one of them is the first frequency band, the wireless resource allocation information includes identifiers and messages format compliant with standards of the at least two frequency bands.

9. An apparatus for allocating resources in a communication system, the apparatus comprising:
a determiner for determining a first frequency band for transmitting wireless resource allocation information to a terminal from among frequency bands supported by the communication system;
a MAP generator for determining at least one second frequency band over which the terminal desires to receive a service and for generating wireless resource allocation information for allocation of the second frequency band; and
a transmission unit for transmitting the wireless resource allocation information to the terminal over the first frequency band.

10. The apparatus of claim 9, wherein when the second frequency band comprises a frequency band different from the first frequency band, the MAP generator generates wireless resource allocation information including an identifier of the second frequency band and a message format compliant with standard of the second frequency band.

11. The apparatus of claim 10, wherein the message format compliant with the standard of the second frequency band comprises a DL_MAP_IE including a Frequency Band Index field and a DL_MAP_IE( ) field.

12. The apparatus of claim 9, wherein when the second frequency band includes at least two different frequency bands and one of them comprises the first frequency band, the MAP generator generates wireless resource allocation information including identifiers and messages format compliant with standards of the at least two frequency bands.

13. An apparatus for receiving wireless resources in a communication system having backward compatibility, the apparatus comprising:
a reception unit for receiving wireless resource allocation information over a first frequency band determined by a base station; and
a MAP information decrypter for checking at least one service frequency band included in the wireless resource allocation information.

14. The apparatus of claim 13, wherein, when the service frequency band comprises a frequency band different from the first frequency band, the wireless resource allocation information comprises an identifier of the service frequency band and a message format compliant with standard of the service frequency band.

15. The apparatus of claim 14, wherein the message format compliant with the standard of the service frequency band comprises a DL_MAP_IE including a Frequency Band Index field and a DL_MAP_IE( ) field.

16. The apparatus of claim 13, wherein, when the service frequency band includes at least two different frequency bands and one of them comprises the first frequency band, the wireless resource allocation information includes identifiers and messages format compliant with standards of the at least two frequency bands.
